(19) United States
(12) Patent Application Publication
(10) Pub. No.: US 2014/0376714 A1
(43) Pub. Date: Dec. 25, 2014

(54) METHOD AND APPARATUS FOR PROCESSING REPETITIVE CALLS TO A HOTLINE

(71) Applicant: Alcatel Lucent, Boulogne Billancourt (FR)

(72) Inventors: Xuan Zhi Fan, Qingdao (CN); Rocky Liu, Qingdao (CN)

(73) Assignee: Alcatel Lucent, Boulogne Billancourt (FR)

(21) Appl. No.: 14/373,433

(22) PCT Filed: Jan. 21, 2013
(86) PCT No.: PCT/IB2013/000526

§ 371 Date: Jul. 21, 2014

(30) Foreign Application Priority Data
Jan. 21, 2012 (CN) 201210020098.8

(51) Int. Cl. H04M 3/523

(52) U.S. Cl. CPC H04M 3/5238; H04M 3/5235; H04M 2203/408
USPC 379/265.11

(57) ABSTRACT

The present invention provides a method and apparatus for processing a hotline. The present invention introduces a client-customer service relationship correspondence table in a multiple line hunt group. When a client dials a hotline for the first time for a problem, the multiple line hunt group will select a customer service and save a correspondence relationship between the client and the customer service. When the client dials the hotline again, the multiple line hunt group will first query whether records of the client exist in the client-customer service relationship correspondence table; if yes, obtains a corresponding customer service to establish a call. If not, one is selected from idle customer services. By using the present method, when the client needs to dial the hotline for multiple times for a problem, it may be guaranteed that it is the same customer service who serves the client. In this way, the present method not only saves the client's time and provides great convenience to the client, it may also save valuable customer service resources at the same time.

### FIELD OF THE INVENTION

The present invention relates to a communication network, and more specifically, to a method and apparatus for processing hotline in the communication network.

### BACKGROUND OF THE INVENTION

With expedite development of businesses, more and more merchants or enterprises provide hotline services. When a client needs consultation or complaint, he/she will call a hotline number, and then a multiple line hunt group corresponding to the hotline number will handle it. A working principle of the multiple line hunt group is generally shown in FIG. 1. In FIG. 1, the multiple line hunt group 100 comprises an application server la, a customer service 101, a customer service 102, a customer service 103, and a customer service 104. Here, the customer service is also an operator. After the multiple line hunt group 100 receives a call from client A, the application server 1a will execute a selecting algorithm to select one from idle personnel among customer service 101—customer service 104 to pick up the call from the client A. In FIG. 1, the application server 1a selects the customer service 101 to pick up the call from the client A and handle the client A's demands. It should be noted that FIG. 1 is merely exemplary. Generally, a multiple line hunt group has dozens or even hundreds of customer services; for each hotline call, the multiple line hunt group will randomly assigns the hotline call to one of the so many customer services.

In reality, such an occasion frequently occurs: for a problem occurring to a client, it will not be resolved until dialing a hotline for several times. With the system shown in FIG. 1 as an example, when the client A first dials the hotline, the application server 1a selects the customer service 101 to pick up the call; the client A states the problem to the customer service 101, and the customer service 101 provides a solution to the client A. However, the Client A's problem is not resolved yet; therefore, he/she dials the hotline for the second time. At this time, the application server la selects the customer service 104 to pick up the call. Because the customer service 104 has no idea about the client A's problem, the client A has to re-state or re-explain his/her problem, as well as the solution provided by the customer service 101 and the condition after implementing the solution. If the client A has to dial the hotline for the same problem for several times, the customer services encountered by the client A may well be different for each dial of the hotline according to the current working pattern of the multiple line hunt group, and the client A has to make re-statements or explanations over and again. For client A, it is not only time-consuming but also rather inconvenient to re-explain the problem and state the solution provided by the previous customer service and the condition after implementation; besides, different customer services have a different understanding on the problem, and the client A might have to spend much time and energy to make himself/herself understood by each customer service about this problem. Apparently, customer experience arising from a multiple line hunt group in this pattern is very poor, and each customer service has to spend much time to understand the problem, which will not only waste valuable customer service resources, but also lower the efficiency of resolving the problem.

In order to serve customers better, each customer service may dictate the problem and relevant information of the client after hearing the client's call. When other customer services receive a call from the client, they may browse relevant dictations. However, due to limitations of dictation and potential ambiguities, it might occur that the other customer services cannot understand yet; at this point, the client still has to repeat the already made statements and explanations.

Therefore, when a client has to dial a hotline for a same problem for multiple times, the hotline service in the prior art has drawbacks such as inconveniency for the client to use, wasting time and resources, and low efficiency.

### SUMMARY OF THE INVENTION

In order to solve the above drawbacks in the prior art, there is provided a method and apparatus for processing a hotline.

According to a first aspect of the present invention, there is provided a method for processing a hotline in an application server, said method comprising the following steps: A. receiving a hotline request from a client; B. determining whether a record of said client exists in a client-customer service correspondence table; C. processing said hotline request based on a result of the determining.

Preferably, when the result of determining in step B is negative, step C further comprises the following steps: C11. selecting one customer service from idle customer services; C12. establishing a call between said client and said customer service; C13. saving a correspondence relationship between said client and said customer service in said client-customer service correspondence table.

Preferably, when the result of the determining in step B is positive, step C further comprises the following steps: C21: obtaining a corresponding customer service based on said client-customer service correspondence table and said client; C22: determining whether said customer service is idle; C23: if said customer service is idle, establishing a call between said client and said customer service.

Preferably, when the result of the determining in step C22 is that the customer service is not idle, step C further comprises the following steps: C24: sending a notification to said client; C25: receiving reply information from said client; C26: processing said hotline request based on the reply information from the client.

Preferably, when the reply information in step C25 is willingness to wait, the step C26 further comprises: C2611: monitoring whether said customer service is in an idle state; C2612: if said customer service is monitored to be in the idle state, establishing a call between said client and said customer service.

Preferably, when the reply information in step C25 is unwillingness to wait, the step C26 further comprises: C2621: selecting one customer service from idle customer services; C2622: establishing a call between said client and said customer service; C2623: saving a correspondence relationship between said client and said customer service in the client-customer service correspondence table.

Preferably, the method further comprises the following steps: D. deleting the record in said client-customer service correspondence table.

According to a second aspect of the present invention, there is provided an apparatus for processing a hotline in an application server, said apparatus comprising: a first receiving device configured to receive a hotline request from a client; a first determining device configured to determine whether a record of said client exists in a client-customer service correspondence table; a first processing device configured to process said hotline request based on a result of the determining.

Preferably, when a determining result of the first determining device is negative, the first processing device further comprises: a first selecting device configured to select one customer service from idle customer services; a first establishing device configured to establish a call between said client and said customer service; and a first saving device configured to save a correspondence relationship between said client and said customer service.

Preferably, when a result of determining by the first determining device is positive, the first processing device further comprises: a first obtaining device configured to obtain a corresponding customer service based on said client-customer service correspondence table and said client; a second determining device configured to determine whether the customer service is idle; a second establishing device configured to establish a call between said client and said customer service when the result of determining by the second determining device is that said customer service is idle.

Preferably, when a result of determining by the second determining device is that the customer service is not idle, the first processing device further comprises: a second sending device configured to send a notification to said client; a second receiving device configured to receive reply information from said client; a second processing device configured to process said hotline request based on the reply information from the client.

Preferably, when the reply information received from the second determining device is willingness to wait, the second processing device further comprises: a monitoring device configured to monitor whether said customer service is in an idle state; a third establishing device configured to establish a call between said client and said customer service if said customer service is monitored to be in the idle state.

Preferably, when the reply information received from the second determining device is unwillingness to wait, the second processing device further comprises: a second selecting device configured to select one customer service from idle customer services; a fourth establishing device configured to establish a call between said client and said customer service; a second saving device configured to save a correspondence relationship between said client and said customer service.

Preferably, the apparatus further comprises: a deleting device configured to delete the record in the client-customer service correspondence table.

Compared with the prior art, through using the method and apparatus of the present invention, when a client has to dial a hotline for many times about a certain problem, the multiple line hunt group may guarantee that it is the same customer service that provides services to the client. In this way, the following advantages can be achieved: 1) saving the client's time and energy and improving customer experience. Because it is the same customer service that serves the client for each time, the client may save the time and energy for re-explanation, which brings great convenience to the client. 2) saving valuable customer service resources. Apparently, the time spent by the same customer service for serving a client for multiple times must be far less than the time spent by multiple customer services for serving the client. 3) improving the efficiency of problem resolving. The same customer service serves the client all the way; because the customer service knows well the cause of the problem and the solving progress, he/she can find a better solution faster, thereby improving the efficiency of problem resolving.

### BRIEF DESCRIPTION OF THE SEVERAL VIEWS OF THE DRAWINGS

Through reading the following detailed depiction on the non-limiting embodiments with reference to the accompanying drawings, the other features, objectives, and advantages of the present invention will become more apparent.

FIG. 1 shows a schematic diagram of an application scenario of a multiple line hunt group according to the prior art;

FIG. 2 is a diagram of an application scenario of a multiple line hunt group according to a preferred embodiment of the present invention;

FIG. 3 is a flowchart of a method for processing a hotline in an application server according to a preferred embodiment of the present invention;

FIG. 4 is a flowchart of a substep of a method for processing a hotline in an application server according to a preferred embodiment of the present invention;

FIG. 5 is a flowchart of a substep of a method for processing a hotline in an application server according to a preferred embodiment of the present invention;

FIG. 6 is a flowchart of a substep of a method for processing a hotline in an application server according to a preferred embodiment of the present invention;

FIG. 7 is a flowchart of a substep of a method for processing a hotline in an application server according to a preferred embodiment of the present invention;

FIG. 8 is a flowchart of a substep of a method for processing a hotline in an application server according to a preferred embodiment of the present invention;

FIG. 9 is a structural block diagram of an apparatus for processing a hotline in an application server according to a preferred embodiment of the present invention.

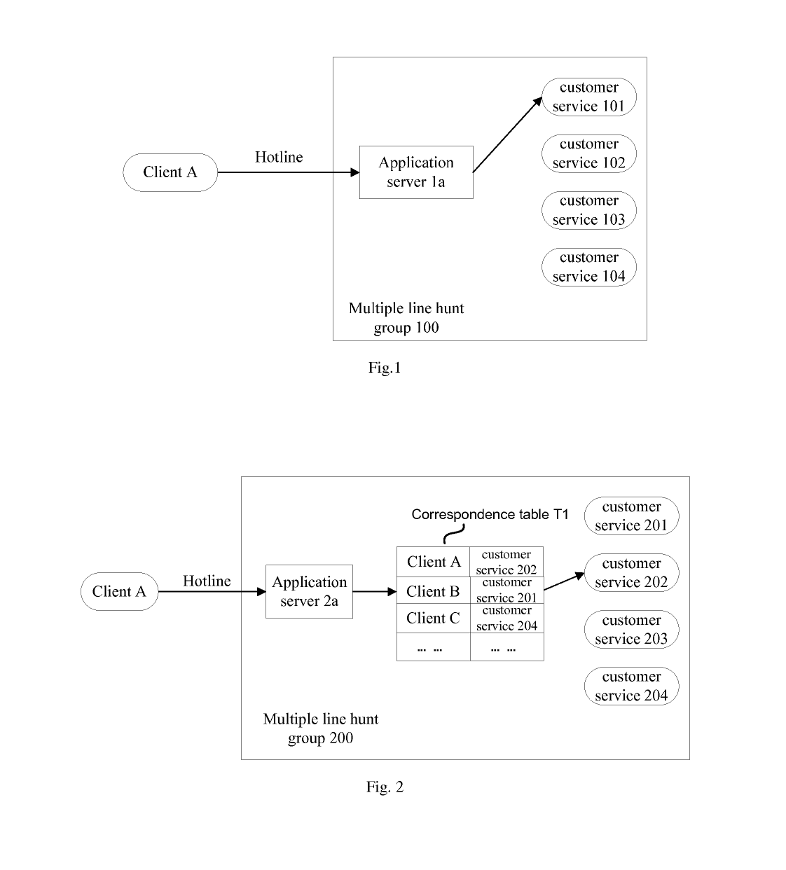

### DETAILED DESCRIPTION OF THE INVENTION

A basic idea of the present invention is to introduce a client-customer service correspondence table in a multiple line hunt group, wherein the client-customer service correspondence table records a correspondence relationship between a client and a customer service who has recently answered the client.

Hereinafter, the present invention will be described in detail with reference to respective figures.

FIG. 2 is a diagram of an application scenario of a multiple line hunt group according to a preferred embodiment of the present invention. The multiple line hunt group 200 comprises an application server 2a, a client-customer service correspondence table T1, a customer service 201, a customer service 202, a customer service 203, and a customer service 204. The multiple line hunt group 200 receives a hotline request from a client A and assigns the request to a customer service to process, wherein, the client-customer service correspondence table T1 records a correspondence relationship between a client and a customer service.

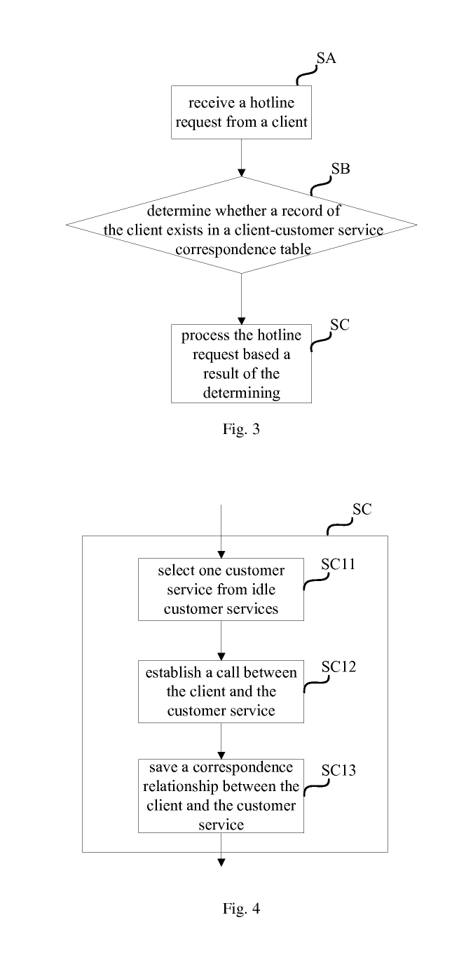

FIG. 3 is a flowchart of a method for processing a hotline in an application server 2a according to a preferred embodiment of the present invention. As shown in the figure, the method starts from step SA.

In step SA, the application server 2a receives a hotline request from the client A.

Next, in step SB, the application server 2a determines whether a record of client A exists in the client-customer service correspondence table T1.

Then, in step SC, the application server 2a processes said hotline request based on a result of determining in step SB.

FIG. 4 shows a flow chart of step SC according to one preferred embodiment of the present invention. In this embodiment, the result of determining in step SB is that no records of the client A exist in the client-customer service correspondence table T1. As shown in the figure, step SC further comprises steps SC11, SC12, and SC13 in this embodiment.

In step SC11, the application server 2a selects one customer service from currently idle customer services. For example, the currently idle customer services are customer service 202 and customer service 204; after a certain algorithm is executed, the application server 2a selects the customer server 202.

Next, in step SC12, the application server 2a establishes a call between the client A and the selected customer service (for example, customer service 202).

Then, in step SC13, the application server 2a saves a correspondence relationship between the client A and the selected customer service (for example, customer service 202) in the client-customer service correspondence table T1. Specifically, a record is added into the client-customer service corresponding table T1 to record the client A—customer service 102 correspondence relationship. In this way, when the client A dials a hotline for a problem and the application server 2a selects a customer service, it further saves the correspondence relationship between the client A and the customer service at the same time, so as to be available for the next time the client A dials the hotline for the same problem.

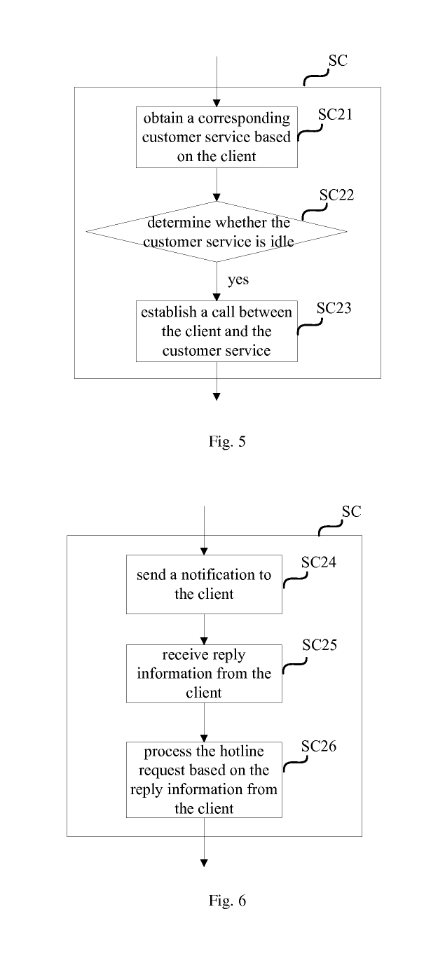

FIG. 5 shows a flow chart of step SC according to one preferred embodiment of the present invention. In this embodiment, the result of determining in step SB is that record of the client A exists in the client-customer service correspondence table T1. As shown in the figure, step SC further comprises steps SC21, SC22, and SC23 in this embodiment.

In step SC21, the application server 2a obtains the customer service corresponding to the client A based on the client-customer service correspondence table T1 and the client A. For example, as shown in FIG. 2, it is derived from the client-customer correspondence table T1 that the customer service corresponding to the client A is the customer service 202. It is seen that when the client A dials the hotline again for the same problem, the application server 2a may obtain the customer service having a call with the client A in the last time based on the records saved in the client-customer service correspondence table T1.

In step SC22, the application server 2a determines whether the customer service (for example, customer service 202) obtained in step SC21 is idle.

In step SC23, if said customer service is idle, the application server 2a establishes a call between the client A and said customer service. In this way, the client A may directly communicates with the customer service having a call therewith in the last time, which provides a great convenience to the client A and meanwhile saves precious time and resources.

FIG. 6 shows a flow chart of step SC according to one preferred embodiment of the present invention. The embodiment of FIG. 6 is a further supplementation to the embodiment of FIG. 5. In this embodiment, the result of determining in step SC22 is that the customer service is not idle. As shown in the figure, step SC further comprises steps SC24, SC25, and SC26 in this embodiment.

In step SC24, the application server 2a sends a notification to the client A to notifies the client A that the customer service (for example, customer service 202 in the above example) obtained in step SC21 is currently busy and whether he/she is willing to wait.

In step SC25, the application server 2a receives reply information from the client A.

In step SC26, the application server 2a processes the hotline request based on the reply information from the client A.

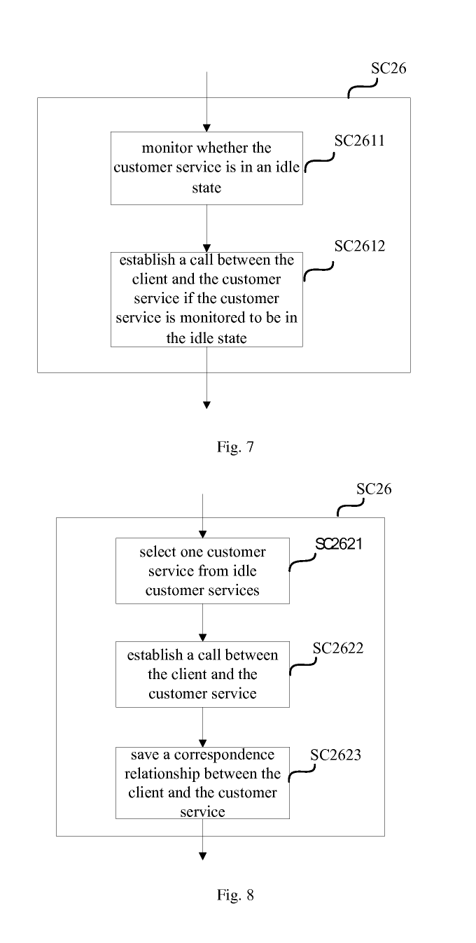

FIG. 7 shows a flow chart of step SC26 according to one preferred embodiment of the present invention. In this embodiment, the reply information from the client A in step SC25 is that he/she is willing to wait. As shown in the figure, step SC26 further comprises steps SC2611 and SC2612 in this embodiment.

In step SC2611, the application server 2a monitors whether the customer service (for example, customer service 202) obtained in step SC21 is in an idle state.

In step SC2612, when the application server 2a monitors that said customer service is in an idle state, it establishes a call between the client A and said customer service.

It is seen that when the current state of the customer service having a call with the client A in the last time is busy and the client A is willing to wait, the application server 2a will constantly monitors the state of the customer service, such that once his/her state is changed to be idle, a call will be established between the client A and the customer service. This may likewise guarantee that the customer service who serves the client A is still the customer service having a call therewith in the last time.

FIG. 8 shows a flow chart of step SC26 according to one preferred embodiment of the present invention. In this embodiment, the reply information from the client A in step SC25 is that he/she is unwilling to wait. As shown in the figure, step SC26 further comprises steps SC2621, SC2622, and SC2623 in this embodiment.

In step SC2621, the application server 2a selects one customer service from currently idle customer services. For example, the currently idle customer services are customer service 202 and customer service 204; after a certain algorithm is executed, the application server 2a selects the customer server 202.

Next, in step SC2622, the application server 2a establishes a call between the client A and the selected customer service (for example, customer service 202).

Then, in step SC2623, the application server 2a saves a correspondence relationship between the client A and the selected customer service (for example, customer service 202) in the client-customer service correspondence table T1. Specifically, a record is added into the client-customer service corresponding table T1 to record the client A—customer service 102 correspondence relationship.

It is seen that when the current state of the customer service having a call with the client A in the last time is busy and the client A is unwilling to wait, the application server 2a will select a customer service from the idle customer services and meanwhile saves the correspondence relationship between the client A and the customer service so as to be available for the next time the client A dials the hotline for the same problem.

Preferably, the method for processing a hotline in the application server 2a may further comprise a step SD: deleting the record in the client-customer service correspondence table T1. This deleting operation may be implemented manually or automatically. For example, the application server 2a automatically deletes the record in the client-customer service correspondence table T1 with an interval of a fixed period (for example, every two months or three months). Or, after it is known that the problem of client A has been resolved, the record of the client A in the client-customer service correspondence table T1 is manually deleted.

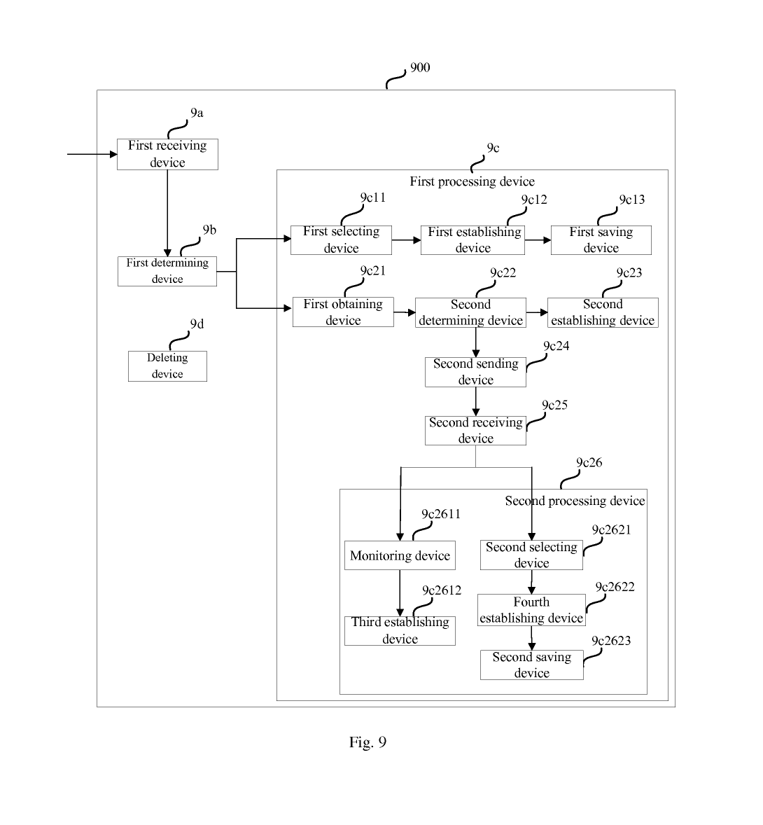

FIG. 9 is a structural block diagram of an apparatus for processing a hotline in an application server 2a according to a preferred embodiment of the present invention. In FIG. 9, the apparatus 900 comprises a first receiving device 9a, a first determining device 9b, and a first processing device 9c.

Hereinafter, the working process of the apparatus 900 will be described in detail.

First, the first receiving device 9a receives a hotline request from the client A.

Next, the first determining device 9b determines whether a record of client A exists in the client-customer service correspondence table T1.

Then, the first processing device 9c processes said hotline request based on a result of determining in step SB.

In an embodiment, the result of the determining by the first determining device is that no records of the client A exist in the client-customer service correspondence table T1. In this embodiment, the first processing device 9c further comprises a first selecting device 9c11, a first establishing device 9c12 and a first saving device 9c13.

First, the first selecting device 9c11 selects one customer service from currently idle customer services. For example, the currently idle customer services are customer service 202 and customer service 204; after a certain algorithm is executed, the first selecting device 9c11 selects the customer server 202.

Next, the first establishing device 9c12 establishes a call between the client A and the selected customer service (for example, customer service 202 in the above example).

Then, the first saving device 9c13 saves a correspondence relationship between the client A and the selected customer service (for example, customer service 202) in the client-customer service correspondence table T1. Specifically, a record is added into the client-customer service corresponding table T1 to record the client A—customer service 102 correspondence relationship. In this way, when the client A dials a hotline for a problem and the application server 2a selects a customer service, it further saves the correspondence relationship between the client A and the customer service at the same time, so as to be available for the next time the client A dials the hotline for the same problem.

In another embodiment, the result of the determining by the first determining device is that the record of the client A exists in the client-customer service correspondence table T1. In this embodiment, the first processing device 9c further comprises a first obtaining device 9c21, a second determining device 9c22 and a second establishing device 9c23.

First, the first obtaining device 9c21 obtains the customer service corresponding to the client A based on the client-customer service correspondence table T1 and the client A. For example, as shown in FIG. 2, it is derived from the client-customer correspondence table T1 that the customer service corresponding to the client A is the customer service 202. It is seen that when the client A dials the hotline again for the same problem, the application server 2a may obtain the customer service having a call with the client A in the last time based on the records saved in the client-customer service correspondence table T1.

Next, the second determining device 9c22 determines whether the customer service (for example, customer service 202) obtained by the first obtaining device 9c21 is idle.

If the second determining device 9c22 determines said customer service is idle, the second establishing device 9c23 establishes a call between the client A and said customer service. In this way, the client A may directly communicates with the customer service having a call therewith in the last time, which provides a great convenience to the client A and meanwhile saves precious time and resources.

In another embodiment, the result of determining by the second determining device is that the customer service is not idle. In this embodiment, the first processing device 9c further comprises a second sending device 9c24, a second receiving device 9c25 and a second processing device 9c26.

The second sending device 9c24 sends a notification to the client A to notifies the client A that the customer service (for example, customer service 202 in the above example) obtained by the first obtaining device 9c21 is currently busy and whether he/she is willing to wait.

The second receiving device 9c25 receives reply information from the client A.

The second processing device 9c26 processes the hotline request based on the reply information from the client A.

In an embodiment, the reply information received from the second determining device 9c25 is willingness to wait. As shown in the figure, in this embodiment, the second processing device 9c26 further comprises a monitoring device 9c2611 and a third establishing device 9c2612.

The monitoring device 9c2611 monitors whether the customer service (for example, customer service 202 in the above example) obtained by the first obtaining device 9c21 is in an idle state.

When the monitoring device 9c2611 monitors that said customer service is in an idle state, the third establishing device 9c2612 establishes a call between the client A and said customer service.

It is seen that when the current state of the customer service having a call with the client A in the last time is busy and the client A is willing to wait, the application server 2a will constantly monitors the state of the customer service, such that once his/her state is changed to be idle, a call will be established between the client A and the customer service. This may likewise guarantee that the customer service who serves the client A is still the customer service having a call therewith in the last time.

In another embodiment, when the reply information received from the second determining device 9c25 is unwillingness to wait. As shown in the figure, in this embodiment, the second processing device 9c26 further comprises a second selecting device 9c2621, a fourth establishing device 9c2622 and a second saving device 9c2623.

First, the second selecting device 9c2621 selects one customer service from currently idle customer services. For example, the currently idle customer services are customer service 202 and customer service 204; after a certain algorithm is executed, the second selecting device 9c2621 selects the customer server 202.

Next, the fourth establishing device 9c2622 establishes a call between the client A and the selected customer service (for example, customer service 202).

Then, the second saving device 9c2623 saves a correspondence relationship between the client A and the selected customer service (for example, customer service 202) in the client-customer service correspondence table T1. Specifically, a record is added into the client-customer service corresponding table T1 to record the client A—customer service 102 correspondence relationship.

It is seen that when the current state of the customer service having a call with the client A in the last time is busy and the client A is unwilling to wait, the application server 2a will select a customer service from the idle customer services and meanwhile saves the correspondence relationship between the client A and the customer service so as to be available for the next time the client A dials the hotline for the same problem.

Preferably, the apparatus 900 may further comprise a deleting device 9d configured to delete the record in the client-customer service correspondence table T1. The deleting operation may be automatically implemented by the deleting device 9d. For example, the deleting module 9d automatically deletes the record in the client-customer service correspondence table T1 with an interval of a fixed period (for example, every two months or three months). Or, after it is known that the problem of the client A has been resolved, an operator sends an instruction to the deleting device 9d which, after receiving the command, will delete the record of the customer service A in the client-customer service correspondence table T1.

To those skilled in the art, it is apparent that the present invention is not limited to the details of the above exemplary embodiments, and the present invention may be implemented with other embodiments without departing from the spirit or basic features of the present invention. Thus, in any way, the embodiments should be regarded as exemplary, not limitative; the scope of the present invention is limited by the appended claims, instead of the above depiction. Thus, all variations intended to fall into the meaning and scope of equivalent elements of the claims should be covered within the present invention. Besides, it is apparent that the term “comprise” does not exclude other units or steps, and singularity does not exclude plurality. Terms such as the first and the second are used to indicate names, but do not indicate any particular sequence.

1. A method for processing a hotline in an application server, the method comprising:
receiving a hotline request from a client;
determining whether a record of said client exists in a client-customer service correspondence table;
processing said hotline request based on a result of the determining.

2. The method according to claim 1, wherein, when the result of the determining in determining whether a record of said client exists in a client-customer service correspondence table is negative, processing said hotline request based on a result of the determining further comprises:
selecting one customer service from idle customer services;
establishing a call between said client and said customer service;
saving a correspondence relationship between said client and said customer service in the client-customer service correspondence table.

3. The method according to claim 1, wherein, when the result of the determining in determining whether a record of said client exists in a client-customer service correspondence table is positive, processing said hotline request based on a result of the determining further comprises:
obtaining a corresponding customer service based on said client-customer service correspondence table and said client;
determining whether said customer service is idle;
if said customer service is idle, establishing a call between said client and said customer service.

4. The method according to claim 3, wherein, when the result of the determining in determining whether said customer service is idle is that the customer service is not idle, processing said hotline request based on a result of the determining further comprises:
sending a notification to said client;
receiving reply information from said client;
processing said hotline request based on the reply information from the client.

5. The method according to claim 4, wherein, when the reply information in receiving reply information from said client is willingness to wait, the processing said hotline request based on the reply information from the client further comprises:
monitoring whether said customer service is in an idle state;
if said customer service is monitored to be in the idle state, establishing a call between said client and said customer service.

6. The method according to claim 4, wherein, when the reply information in receiving reply information from said client is unwillingness to wait, the processing said hotline request based on the reply information from the client further comprises:
selecting one customer service from idle customer services;
establishing a call between said client and said customer service;
saving a correspondence relationship between said client and said customer service in the client-customer service correspondence table.

7. The method according to claim 1, wherein, the method further comprises the following steps:
deleting the record in said client-customer service correspondence table.

8. An apparatus for processing a hotline in an application server, said apparatus comprising:
a first receiving device configured to receive a hotline request from a client;
a first determining device configured to determine whether a record of said client exists in a client-customer service correspondence table;
a first processing device configured to process said hotline request based on a result of the determining.

9. The apparatus according to claim 8, wherein, when the result of the determining by the first determining device is negative, the first processing device further comprises:
a first selecting device configured to select one customer service from idle customer services;
a first establishing device configured to establish a call between said client and said customer service;
a first saving device configured to save a correspondence relationship between said client and said customer service.

10. The apparatus according to claim 8, wherein, when a result of determining by the first determining device is positive, the first processing device further comprises:
a first obtaining device configured to obtain a corresponding customer service based on said client-customer service correspondence table and said client;
a second determining device configured to determine whether the customer service is idle;
a second establishing device configured to establish a call between said client and said customer service when the result of determining by the second determining device is that said customer service is idle.

11. The apparatus according to claim 10, wherein, when a result of determining by the second determining device is that the customer service is not idle, the first processing device further comprises:
a second sending device configured to send a notification to said client;
a second receiving device configured to receive reply information from said client; a second processing device configured to process said hotline request based on the reply information from the client.

12. The apparatus according to claim 11, wherein, when the reply information received from the second determining device is willingness to wait, the second processing device further comprises:
a monitoring device configured to monitor whether said customer service is in an idle state;
a third establishing device configured to establish a call between said client and said customer service if said customer service is monitored to be in the idle state.

13. The apparatus according to claim 11, wherein, when the reply information received from the second determining device is unwillingness to wait, the second processing device further comprises:
a second selecting device configured to select one customer service from idle customer services;
a fourth establishing device configured to establish a call between said client and said customer service;
a second saving device configured to save a correspondence relationship between said client and said customer service.

14. The apparatus according to claim 8, wherein, the apparatus further comprises:
a deleting device configured to delete the record in the client-customer service correspondence table.
